(19) United States
(12) Patent Application Publication
(10) Pub. No.: US 2021/0251722 A1
(43) Pub. Date: Aug. 19, 2021

(54) SPACER FOR ENDODONTIC INSTRUMENT

(71) Applicant: Eberhard Karls Universitat Tubingen Medizinische Fakultat, Tubingen (DE)

(72) Inventor: Ashraf Elayouti, Tübingen (DE)

(21) Appl. No.: 17/236,533

(22) Filed: Apr. 21, 2021

Related U.S. Application Data
(63) Continuation of application No. PCT/EP2019/078730, filed on Oct. 22, 2019.

(30) Foreign Application Priority Data
Oct. 22, 2018 (DE) 10 2018 126 242.6

(51) Int. Cl. A61C 5/44

(52) U.S. Cl. CPC A61C 5/44

(57) ABSTRACT

A spacer for an endodontic instrument includes a base surface with a diameter d_{G}, a top surface with a diameter d_{D}, which is smaller than the diameter d_{G}, an axis of rotation, a lateral surface, a height h, an opening with a longitudinal axis for receiving an endodontic instrument and a cylindrical recess for receiving a stopper on the base surface. The spacer is frustoconically formed, and the opening extends from the base surface to the top surface. The longitudinal axis of the opening is coaxial to the axis of rotation of the spacer, and the cylindrical recess is coaxial to the opening.

### CROSS-REFERENCES TO RELATED APPLICATIONS

This application is a continuation of copending international patent application PCT/EP2019/078730 filed on 22 Oct. 2019 and designating the U.S., which has been published in German, and claims priority from German patent application DE 10 2018 126 242.6 filed on 22 Oct. 2018. The entire contents of these prior applications are incorporated herein by reference.

### FIELD

The invention relates to a spacer for an endodontic instrument, for example for a root canal instrument. The invention further relates to a device for providing such spacers. The invention further relates to a kit for use during an endodontic treatment, comprising the spacer according to the invention and the device according to the invention.

### BACKGROUND

Endodontic instruments, such as files and reamers, including hand instruments and rotary instruments, are commonly used for cleaning and expanding the root canal of infected teeth. In the treatment of diseased tooth root canals, the pulpa tissue is removed in order to gain access to the most apical end of the tooth in order to completely remove bacteria.

### DESCRIPTION OF RELATED ART

Various methods are known for determining the length of the roots or canals of the tooth; for example, the length of the root canals can be determined using special measuring needles and an x-ray image or by means of an electrical measuring device. This is necessary in order to be able to guarantee a supply up to the root tip.

This determined maximum penetration depth is conventionally set by means of a stop ring that is placed on the instruments. The stop ring is made of an elastic plastic, for example silicone, and has a central bore into which the instrument is inserted. The stop ring is also called a silicone stopper or just a stopper.

### SUMMARY

With the spacer according to the invention, it is possible to precisely and reproducibly determine the instrument length of the endodontic instruments during an endodontic treatment. In other words, a limitation is provided with which the penetration depth of the instrument is precisely defined and does not change inadvertently during the treatment.

For this purpose, during an endodontic treatment, the endodontic instrument is first guided into the opening of the spacer according to the invention, namely up to the distal end of the handle of the endodontic instrument. In other words, the spacer is pushed as far as the stop of the handle of the endodontic instrument, so that the top surface of the spacer rests against the handle, while the base surface of the spacer lies on the tooth crown during the treatment.

### BRIEF DESCRIPTION OF THE DRAWINGS

FIG. 1 is a side view of a spacer according to the invention;

FIG. 2 is a side view of an endodontic instrument extending into a tooth and comprising a spacer limiting the depth of penetration;

FIG. 3 is a side view of an endodontic instrument extending into a tooth and comprising a spacer limiting the depth of penetration and an additional disk;

FIG. 4 is a perspective view of the device according to the invention;

FIG. 5 is a side view of a section of a device according to the invention; and

FIG. 6 is a side view of a section of a device according to the invention with a spacer according to the invention and an endodontic instrument.

### DETAILED DESCRIPTION

The problem with the treatment of the teeth is usually the imprecise adherence to the working length of the instruments. In root treatment, however it is important that the endodontic instruments be inserted into the respective root canal only up to a precisely defined maximum penetration depth. This is to avoid over-instrumentation, the spread of bacteria, pain and other complications during treatment.

According to the prior art, a stopper is pushed onto the instrument, specifically to a reference point in the area of the tooth crown. This reference point is also referred to as the coronal reference point. In order to set the exact position of the stop ring on the respective instrument, a large number of different devices are known from the prior art.

From DE 24 16 275 C2 and DE 34 34 786 C2, for example, measuring gauges are known which have a length scale and a recess at a well-defined point into which the stopper can be inserted. If this has not already been done before, the instrument can now be passed through the central bore of the stop ring and displaced in the direction in which the instrument extends, with the stopper remaining stationary relative to the length scale of the measuring gauge.

The disadvantage here is that the instrument must be pushed through the stopper by hand until the desired position and the desired length of the file of the instrument is reached. This is associated with a certain inaccuracy and insufficient reproducibility of the maximum penetration depth of the instrument, which should be able to be determined with an accuracy of up to a quarter of a millimeter.

From DE 199 16 114 A1, therefore, a setting gauge for setting the depth stop is known, in which the instrument is pushed through the stopper until it hits an adjustable stop. This increases the reproducibility of the set length.

From JP 10 085 243 A, U.S. Pat. Nos. 3,938,253 and 4,028,810 an adjusting device is known in which the maximum penetration depth of the root canal file can be adjusted by a stop which can be adjusted via a threaded rod. This allows the length to be better adjusted.

The aforementioned devices use conventional silicone stoppers. Such stoppers have the disadvantage that, due to their flexible material, they can slip during the treatment, which leads to a change in the maximum penetration depth. This often results in over-instrumentation during root treatment.

From U.S. Pat. No. 5,154,611 a dispenser for silicone stoppers is known, which stores silicone stoppers of different length. These can each be pushed onto an endodontic instrument up to the stop of the handle. This generates a defined length of the file. Although this eliminates the disadvantage of slipping, such dispensers do not meet the requirement of sterility.

Furthermore, it is possible that several root canals have to be cleaned in the course of a dental treatment, so that the instrument has to be set to different maximum penetration depths. For this purpose, the stopper is moved by hand. This has several disadvantages, such as contamination of the instrument but also the risk of injury from moving the stopper. As a result, treatments that are unpleasant or painful for the patient are prolonged.

Accordingly, all devices and methods known in the prior art for determining and adjusting the exact position of a stop ring on the endodontic instrument and maintaining this position during treatment have numerous disadvantages.

Based on the above, it is the object of the present invention to provide a device which can overcome the disadvantages described above in the prior art.

According to the invention, the object is achieved by a spacer for an endodontic instrument comprising: a base surface having a diameter (d_{G}), a top surface having a diameter (d_{D}), wherein the diameter (d_{D}) is smaller than the diameter (d_{G}), an axis of rotation, a lateral surface, a height (h), an opening having a longitudinal axis for receiving an endodontic instrument, and a cylindrical recess for receiving a stopper on the base surface, wherein the spacer is frustoconical, and wherein the opening extends from the base surface to the top surface, wherein the longitudinal axis of the opening is coaxial with the axis of rotation of the spacer, and wherein the cylindrical recess is coaxial with the opening.

According to the invention, the spacer can be configured at different heights. By selecting the height of the spacer, a maximum working length or maximum penetration depth of the endodontic instrument is precisely defined before treatment. In this way, small working lengths can be achieved with large heights, while a correspondingly larger working length can be achieved with small heights.

Slipping of the stopper, so that there is over-instrumentation, as is known in the prior art, is prevented by the invention because the endodontic instrument can only be inserted into the tooth by the remaining length adjoining the spacer.

The invention also offers the advantage that, due to the conical shape of the spacer, the spacers can be changed quickly during treatment. This is particularly necessary if a new or further penetration depth is to be set.

On the one hand, the spacer is larger than conventional stoppers, so that it is easier for a treating physician to release the spacer from the endodontic instrument.

Furthermore, with the removal of the spacer from the endodontic instrument, the stopper (if present) can also advantageously be released from the instrument.

According to the invention, an “endodontic instrument” is understood to mean any instrument which is used in an endodontic treatment, in particular K-files, reamers and Hedström files made of Cr—Ni stainless steel. The ISO standard defines all lengths, thicknesses, dimensions, tolerances and minimum requirements for mechanical strength. The diameter at the instrument tip corresponds to the size 1/100 mm. The length of the conically rising working part is 16 mm regardless of the overall instrument length. All instruments have a conical working part that increases in diameter by 0.02 mm per millimeter, i.e. at the end of the working part the instruments are 0.32 mm thicker. In addition to the 02 conicity, newer instruments made of nickel-titanium also have more sharply increasing conical instrument shapes: e.g. 04, 06, 10, and 12. To facilitate instrument use, the instrument handles are color-coded.

According to the invention, an “endodontic instrument” also includes a dental drilling instrument.

According to the invention, a “stopper” is understood to mean a ring made of a suitable material, preferably made of plastic or rubber, which can be attached to the endodontic instrument in a form-fitting manner. These are also known as silicone stoppers, endo stoppers or endo stops. Such stoppers are known in the art and are commonly used in endodontic treatment. These stoppers are available in various sizes, the usual size having a diameter of 3.5 mm and a thickness/height of 1 mm.

According to the invention, the opening for receiving an endodontic instrument is configured such that the opening has at least the same diameter as the cross section of the endodontic instrument which is inserted into the opening.

According to the invention, the opening can be a circular bore. According to the invention the opening can also have other shapes, for example triangular, square or polygonal.

According to a preferred embodiment of the spacer according to the invention, the cylindrical recess for receiving a stopper has a volume which corresponds to the volume of a stopper.

This embodiment has the advantage that already known, established techniques can be combined with the invention. For this purpose, the spacer according to the invention has a cylindrical recess in which a stopper can be received without gaps or in a form-fitting manner. This embodiment also offers the advantage that a stopper can be additionally fix the spacer on the endodontic instrument.

According to a preferred embodiment of the spacer according to the invention, the cylindrical recess for receiving a stopper has a diameter which is 2.0 mm to 5.0 mm, preferably 2.0, 2.5, 3.0, 3.5, 4.0, 4.5, or 5.0 mm.

In another embodiment of the spacer according to the invention, the cylindrical recess for receiving a stopper has a height which is 0.5 mm to 2.0 mm, preferably 0.5, 1.0, 1.5 or 2.0 mm.

The stoppers known in the prior art have different heights/thicknesses as well as different diameters. These embodiments therefore offer the advantage that any stopper can be combined with the spacer according to the invention.

According to a preferred embodiment of the spacer according to the invention, the diameter (d_{G}) is 5.0 mm to 15.0 mm, preferably 5.0, 5.5, 6.0, 6.5, 7.0, 7.5, 8.0, 8.5, 9.0, 9.5, 10.0, 10.5, 11.0, 11.5, 12.0, 12.5, 13.0 13.5, 14.0, 14.5 or 15.0 mm.

According to the invention, the diameter of the base surface corresponds approximately to the diameter of the tooth crown or the restauration of the tooth to be treated. The diameter is selected such that the spacer rests on the respective tooth crowns. If the diameter is selected too small, the spacer may not rest on the tooth crown but, for example, in the tooth fissures. If the selected diameter is too large, the spacer may rest on adjacent teeth of the tooth to be treated. Accordingly, incorrectly selected diameters can lead to incorrect treatment.

According to the invention numerous spacers according to the invention in various sizes are available to a treating physician during treatment. A person skilled in the art will be able to select a suitable spacer depending on the nature of the tooth to be treated.

According to a preferred embodiment of the spacer according to the invention, the height (h) is approx. 0.75 mm to approx. 15 mm, preferably approx. 0.75, 1.0, 1.5, 2.0, 2.5, 3.0, 3.5, 4.0, 4.5, 5.0, 6.0, 7.0, 8.0, 9.0, 10.0, 11.0, 12.0 13.0 14.0 or approx. 15.0 mm.

The height of the spacer determines the maximum penetration depth of the endodontic instrument during treatment of the tooth. According to the invention, various spacers of different heights are available to the physician in order to be able to set the exact working length of the endodontic instrument.

In order to be able to set the exact working length, the spacer can be supplemented according to the invention by additional disks with an opening for receiving endodontic instruments. These disks serve to finely enlarge the spacer beyond the height (h).

These disks can have a height of ≤0.5 mm. Possible thicknesses/heights can be approx. 0.1, 0.15, 0.2, 0.25, 0.3, 0.35, 0.4, 0.45 or approx. 0.5 mm. During the treatment, these disks can either rest against the base surface or the top surface of the spacer.

In addition to disks, according to the invention, several spacers can also be pushed onto the endodontic instrument one behind the other in order to be able to set the desired or exact working length.

This embodiment offers the advantage that any working size of the endodontic instrument can be adjusted; either by using a spacer of a defined height or the combination of multiple spacers or the combination of spacer and additional disks.

According to a preferred embodiment of the spacer according to the invention, the opening for receiving an endodontic instrument has a diameter (d_{O}) of ≤2.0 mm, preferably approx. 2.0, 1.9, 1.8, 1.7, 1.6, 1.5, 1.4, 1.3, 1.2, 1.1, 1.0, 0.9, 0.8, 0.75, 0.7, 0.65, 0.6, 0.55, 0.5, 0.45, 0.4, 0.35, 0.3, 0.25, 0.2 or approx. 0.15 mm.

Endodontic instruments are usually offered in different thicknesses or diameters. This is necessary because the root canals can also have different diameters.

This embodiment has the advantage that all endodontic instruments can be combined with the spacer according to the invention.

According to a preferred embodiment of the spacer according to the invention, the diameter (d_{D}) is from 2.5 mm to 15.0 mm, preferably of 2.5, 3.0, 3.5, 4.0, 4.5, 5.0, 5.5, 6.0, 6.5, 7.0, 7.5, 8.0, 9.0, 9.5, 10, 10.5, 11, 11.5, 12, 12.5, 13, 13.5, 14, 14.5 or 15.0 mm.

This embodiment has the advantage that the spacer is not significantly larger than the tooth to be treated. This has the advantage that the dentist has a good view on the tooth to be treated.

Preferably, the spacer is made of material which is dimensionally stable. Furthermore, the material should be chemically inert and remain dimensionally stable at high temperatures and pressures. This is particularly advantageous because the spacer can thus be easily sterilized. Furthermore, the material should be inert to bacteria, viruses or fungi.

According to a preferred embodiment of the spacer according to the invention, the spacer is made of metal, plastic, silicone, or a combination thereof, preferably PEEK (polyetheretherketone), PPSU, POM-C or stainless steel.

This embodiment offers the advantage that all materials can be easily sterilized. This has the advantage that the spacers can be used several times. This in turn can lead to cost savings.

The materials also offer the advantage that the spacer can be molded during manufacturing, which allows for low cost manufacturing.

According to a preferred embodiment of the spacer according to the invention, the spacer comprises a marker which indicates the height (h).

According to the invention, markers are understood to mean all indications which can quickly and reliably indicate to a treating physician the height of the respective spacer.

Such markers may be imprints; for example, the respective heights may be printed in numbers or graphics on the spacer. Further, the height indication may also be engraved or stamped. According to the invention, the height can also be indicated by a color code. In this case, depending on the height the spacers can be colored in different colors or can be made of a colored material.

Color coding has become common in endodontic instruments, so that marking by means of colors is a preferred embodiment.

According to the invention, the object is further achieved by a device for providing the spacer according to the invention, comprising: a body which has at least one recess for receiving the spacer in an at least partially form-fitting manner.

The spacer can be quickly and safely inserted into this device and removed again if necessary. The spacer can also be inserted and clamped into this device when it is plugged onto an endodontic instrument. Subsequently, the endodontic instrument can be safely separated from the spacer according to the invention and, if necessary, guided into another spacer with different dimensions. This enables the spacer to be changed quickly and safely on the endodontic instrument.

A particular advantage of the device according to the invention is that the treating physician can place the spacer on the endodontic instrument and may change it during an endodontic treatment, without the physician having to pick up the spacer. In the prior art, this regularly leads to unwanted contamination, since the physician has to move the originally sterilized stopper by hand.

The recess of the device according to the invention is advantageously configured in such a way that the spacer can easily be inserted into the device and can become jammed in it. In particular, it is preferred if the recess is configured such that the spacer can be inserted and released from the device only in the lateral direction and not vertically upwards or downwards.

According to the invention, the device may have multiple recesses, for example, 2, 3, 4, 5, 6, 7, 8, 9, 10, 20, 30, 40, etc. According to this embodiment, for example, several spacers of different sizes may be stocked in the respective recesses of the device. This has the advantage that the treating physician can quickly change the spacer from the endodontic instrument.

According to a preferred embodiment of the device, the recess is frustoconically shaped or shaped like a truncated pyramid.

This embodiment offers the advantage that the spacer can be inserted into the device with a precise fit, since it is frustoconically shaped.

According to another preferred embodiment of the device, the at least partially form-fitting receptacle is configured such that the spacer is seated in clamping engagement in the at least one recess.

This embodiment has the advantage that the spacer can be pushed laterally into the device, namely into the recess. The spacer is clamped in this recess so that it cannot become detached to other sides, for example upwards or downwards.

According to a further embodiment of the device, the device comprises, in the area of the recess, a slit-shaped opening in the bottom of the body extending towards the edge of the body and configured to receive an endodontic instrument.

According to another embodiment of the device, the slit-shaped opening has a diameter of ≤2.0 mm, preferably of approx. 2.0, 1.9, 1.8, 1.7, 1.6, 1.5, 1.4, 1.3, 1.2, 1.1, 1.0, 0.9, 0.8, 0.75 0.7, 0.65, 0.6, 0.55, 0.5, 0.45, 0.4, 0.35, 0.3, 0.25, 0.2 or approx. 0.15 mm.

These embodiments have the advantage that the spacer is usually pushed into the device in conjunction with an endodontic instrument. Accordingly, the slit-shaped opening enables the spacer from the endodontic instrument to be changed easily and safely.

According to the invention, the slit-shaped opening is thus configured in such a way that an endodontic instrument has sufficient space in the slit-shaped opening and is not clamped in like the spacer itself.

According to the invention, the object is further achieved by a kit for use during an endodontic treatment, comprising a device according to the invention and a spacer according to the invention.

According to an embodiment of the kit, the kit comprises a disk for fine enlargement of the spacer, wherein the disk has a height of ≤0.5 mm.

Further advantages will be apparent from the figures and the following description of preferred embodiments.

It is understood that the above features and those to be explained below can be used not only in the respectively specified combination but also in other combinations or on their own without departing from the scope of the present invention.

Exemplary embodiments of the invention are shown in the drawings and are explained in more detail below.

Functionally equivalent elements are identified by the same reference signs in all figures, even in different embodiments.

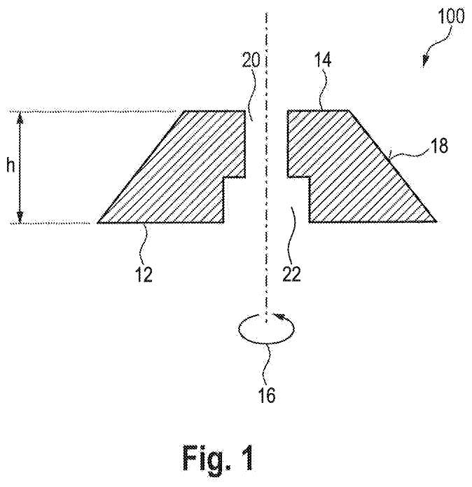

FIG. 1 shows a spacer 100 according to the invention for an endodontic instrument 10. The spacer 100 is frustoconically configured and has an axis of rotation 16. The spacer 100 is characterized in that it comprises a base surface 12, a top surface 14, a lateral surface 18, and a height h. The top surface 14 is smaller than the base surface 12.

Furthermore, the spacer 100 comprises an opening 20 for receiving an endodontic instrument 10, the opening 20 extending from the base surface 12 to the top surface 14. The opening 20 further comprises a longitudinal axis, the longitudinal axis of the opening 20 being coaxial with the axis of rotation 16 of the spacer 100.

In addition the spacer 100 comprises a cylindrical recess 22 for receiving a stopper 24 on the base surface 12, the cylindrical recess 22 being arranged coaxially to the opening 20.

According to the invention, the spacer 100 can be variable in size. This is advantageous because the spacer 100 is selected depending on the tooth to be treated and in particular its tooth root length. The diameter of the base surface 12, the diameter of the top surface 14, the diameter of the opening 20, the diameter of the cylindrical recess 22, as well as the height h of the spacer 100 and the height of the cylindrical recess 22 are variable here.

The spacer 100 is preferably made of materials that can be easily sterilized, are dimensionally stable and chemically inert.

In accordance with the invention, the spacer 100 may comprise markers indicating the height of the spacer 100 (not shown). This can be achieved, for example, by color coding on the spacer 100 or coloring the spacer 100 entirely.

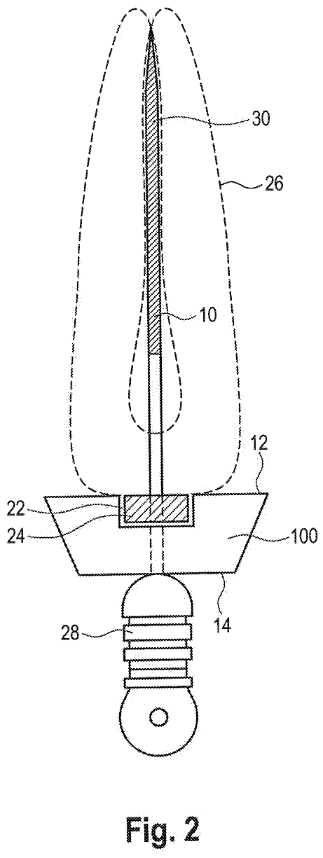

FIG. 2 shows a side view of an endodontic instrument 10 which extends into a tooth 26 and comprises a spacer 100 which limits the depth of penetration.

As can be seen from FIG. 2, the endodontic instrument 10 has an elongated shape. It is composed of a handle 28 and a treatment head 30, which usually represents the drill head or the file. The endodontic instrument 10 extends in FIG. 2 into the root canal of the tooth 26 up to the most apical end of the tooth 26.

In this regard, the spacer 100 is arranged such that the base surface 12 abuts the crown of the tooth 14 and the top surface 14 abuts the distal end of the handle 28, thereby defining the maximum penetration depth of the endodontic instrument 10 by the height of the spacer 100.

Further shown in FIG. 2 is a stopper 24 received in the cylindrical recess 22 of the spacer 100. Advantageously, the stopper 24 can be used to firmly secure the spacer 100 to the endodontic instrument 10.

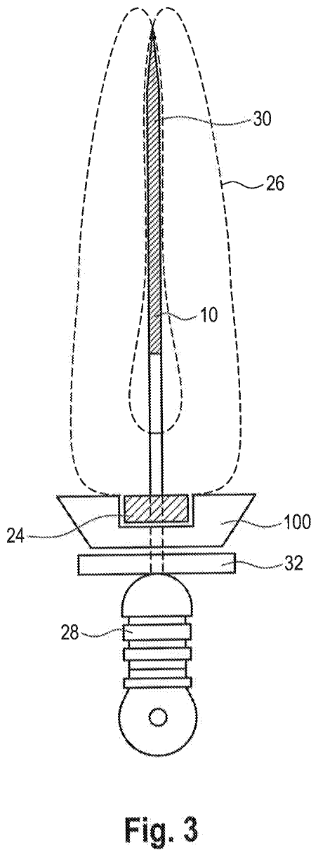

FIG. 3 differs from FIG. 2 in having an additional disk 32 located between the handle 28 of the endodontic instrument 10 and the top surface 14 of the spacer 100. According to the invention, the disk 32 may also be located between the tooth crown and the base surface 12 of the spacer 100 (not shown).

The disk 32 is advantageous because it can be used to fine tune the penetration depth. In contrast to the spacer 100, the disk 32 can also have very small heights of, for example ≤0.5 mm.

According to the invention, several disks 32 and several spacers 100 can also be attached one behind the other on the endodontic instrument 10 in order to achieve a desired working length of the endodontic instrument 10.

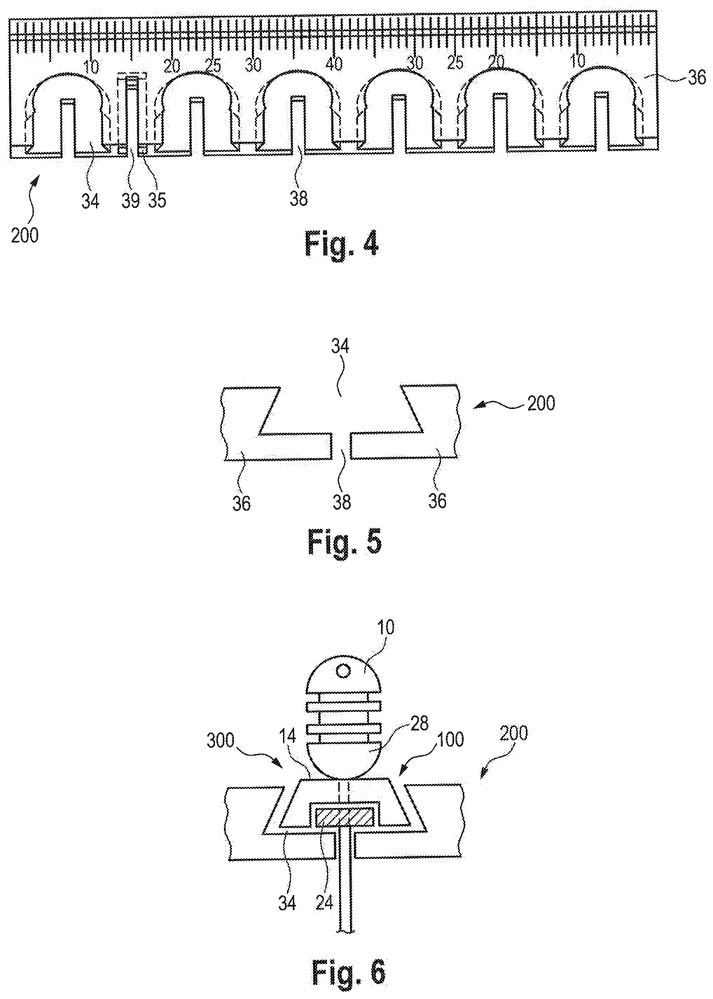

FIG. 4 shows a perspective view of the device 200 according to the invention. It shows a device 200 for providing a spacer 100 according to the invention, the device 200 having a recess 34 for receiving the spacer 100 in an at least partially form-fitting manner.

The device 200 shown in FIG. 4 has six recesses 34 in a body 36, in each of which a spacer 100 (not shown) can be received. The recesses 34 are configured in such a way that they are partially designed in the shape of a truncated pyramid and partially frustoconically designed, the recess 34 being designed in the shape of a truncated pyramid toward the edge.

The spacer 100 can be received in the recess 34 at least partially in a form-fitting manner. The spacer 100 can be received in a clamping engagement.

The recess 34 further comprises a slit-shaped opening 38 in the bottom of the body 36 extending toward the edge of the body 36, the opening being configured to receive an endodontic instrument 10.

In the device 200, a further recess 35 for receiving the stopper 24 (not shown) is also provided. The further recess 35 is configured in such a way that the stopper 24 can be received at least partially in a form-fitting manner, preferably in a clamping engagement. The further recess 35 has a slit-shaped further opening 39 extending towards the edge of the body.

The device 200 according to the invention allows an easy removal of both the spacer 100 and the stopper 24 from the recess 34 and further recess 35, respectively. For this purpose, the endodontic instrument 10 (not shown) is guided from above through the central opening of the spacer 100 located in the recess 34 and the slit-shaped opening 38 in the bottom of the body 36 until the spacer 100 is seated on the shaft of the endodontic instrument 10. In the next step, the stopper 24 is then removed from the further recess 35 in the appropriate manner and then pressed into the cylindrical recess 22 of the spacer 100. The spacer 100 or stopper 24 can be deposited by reversing the procedure.

FIG. 5 shows a side view of a section of a device 200 according to the invention. The device 200 according to the invention for providing the spacer 100 according to the invention can be seen. FIG. 4. and FIG. 5 show the same embodiment of the device 200 and differ only in perspective.

FIG. 6 shows a side view of a section of a device 200 according to the invention with a spacer 100 according to the invention and an endodontic instrument 10.

In this case, the endodontic instrument 10 is guided by the spacer 100 and the stopper 24, with the top surface 14 of the spacer 100 resting against the handle 28 of the endodontic instrument 10. In contrast, the base surface 12 of the spacer 100 rests on the body 36 of the device 200, with the spacer 100 being received in a form-fitting manner in the recess 34 of the device 200. Furthermore, the stopper 24 is also received in the cylindrical recess 22 of the spacer 100.

Assuming that the endodontic instrument 10 would be pulled out of the spacer 100, the spacer 100 and the stopper 24 would remain in the device 200 as they are connected to the device 200 in a clamping engagement.

What is claimed is:

1. A spacer for an endodontic instrument, comprising: a base surface having a diameter d_{G}, a top surface having a diameter d_{D}, wherein the diameter d_{D} is smaller than the diameter d_{G}, an axis of rotation, a lateral surface, a height h, an opening having a longitudinal axis for receiving an endodontic instrument, and a cylindrical recess for receiving a stopper on the base surface, wherein the spacer is frustoconical, and wherein the opening extends from the base surface to the top surface, wherein the longitudinal axis of the opening is coaxial with the axis of rotation of the spacer, and wherein the cylindrical recess is coaxial with the opening.

2. The spacer of claim 1, wherein the cylindrical recess for receiving a stopper comprises a volume which corresponds to the volume of a stopper.

3. The spacer of claim 1, wherein the cylindrical recess for receiving a stopper comprises a diameter of 2.0 mm to 5.0 mm.

4. The spacer of claim 1, wherein the cylindrical recess for receiving a stopper comprises a height which is 0.5 mm to 2.0 mm.

5. The spacer of claim 1, wherein the diameter d_{G} is 5.0 mm to 15.0 mm.

6. The spacer of claim 1, wherein the height h is 0.75 mm to 15 mm.

7. The spacer of claim 1, wherein the opening for receiving an endodontic instruments comprises a diameter d_{O} of ≤2.0 mm.

8. The spacer of claim 1, wherein the diameter d_{D} is from 2.5 mm to 10.0 mm.

9. The spacer of claim 1, wherein it is made of a material which is selected from a group consisting of: metal, plastic, silicone, and a combination thereof, PEEK (polyetheretherketone), PPSU, POM-C and stainless steel.

10. The spacer of claim 1, wherein it comprises a marker indicating the height h.

11. A device for providing the spacer of claim 1, comprising: a body which comprises at least one recess for receiving the spacer at least partially in a form-fitting manner.

12. The device of claim 11, wherein the recess is frustoconically configured or configured like a truncated pyramid.

13. The device of claim 11, wherein the at least partially form-fitting receptacle is configured in such a way that the spacer sits in a clamping engagement in the at least one recess.

14. The device of claim 11, wherein in the area of the recess, a slit-shaped opening extending towards the edge of the body is configured in the bottom of the body for receiving an endodontic instrument.

15. The device of claim 14, wherein the slit-shaped opening comprises a diameter of ≤2.0 mm.

16. A kit for use in an endodontic treatment, comprising a device of claim 11 and a spacer of claim 1.

17. The kit of claim 16, wherein the kit comprises a disk for a fine enlargement of the spacer, wherein the disk comprises a height of ≤0.5 mm.
